(19) United States
(12) Patent Application Publication
(10) Pub. No.: US 2017/0076234 A1
(43) Pub. Date: Mar. 16, 2017

(54) Comprehensive Analytics Tool for Generating User Interfaces Based on Retrieved Data

(71) Applicant: CAPITAL ONE SERVICES, LLC, MCLEAN, VA (US)

(72) Inventors: Adrian Pendell, Frisco, TX (US); Thomas Brooks, Little Elm, TX (US); Jeppe Heidemann, Plano, TX (US)

(21) Appl. No.: 15/265,827

(22) Filed: Sep. 14, 2016

Related U.S. Application Data
(60) Provisional application No. 62/218,103, filed on Sep. 14, 2015.

(51) Int. Cl. G06Q 10/06; H04W 4/02; G06Q 40/02; H04L 12/26

(52) U.S. Cl. CPC G06Q 10/06313; H04L 43/067; H04L 43/045; H04W 4/025; G06Q 40/025

(57) ABSTRACT

An automated computing device for providing a planning and analytics tool is disclosed. In some embodiments, the automated computing device may include a reports module configured to receive a data request for activity data associated with a plurality of entities, locate and retrieve data corresponding to the request, and provide the data corresponding to the request to a client device. In some embodiments, the automated computing device may also include a planning module configured to receive the activity data, identify at least one task for a user to complete based on the activity data, and provide the identified at least one task to the client device.

### PRIORITY

This application claims priority to U.S. Provisional Application No. 62/218,103 filed Sep. 14, 2015, the disclosure of which is hereby incorporated by reference in its entirety.

### BACKGROUND

Many individuals that work in the sales field spend the majority of their time attempting to obtain new customers or providing services to existing customers. These individuals and their managers are often faced with difficult decisions regarding the most effective use of time. On one hand, conducting extensive research prior to interacting with a potential or existing customer may be likely to increase the likelihood that the interaction will be worthwhile for the sales representative. For example, identification of entities that have the most potential for high-profit sales is likely to lead to an individual spending more time pursuing the most desirable customers. On the other hand, research may be time consuming and imperfect, causing the individual performing the research to be out of the field for an extended period of time, possibly resulting in lost opportunities for completing sales or providing services to existing customers. For example, an individual may spend a substantial amount of time looking through historical activity data (e.g., sales data) before making contact with a potential customer, only for it to turn out that the preparation was not financially beneficial because of an unknown factor that is not considered.

As an example, sales representatives in the financial service markets may particularly experience difficulty in finding the most efficient use of their time while also satisfying required sales protocols and best practices on a day-to-day basis. For instance, individuals involved in the sale or marketing of financial services (e.g., loans, credit cards, etc.) may have at their disposal a substantial amount of financial data (e.g., financial performance, location, market, etc.) that they may attempt to use to focus on particular areas or markets. Alternatively, a sales representative in the field of automobile financing may attempt to identify certain automobile sales dealerships that have the potential to be the most profitable for their employing financial service provider (e.g., high loan volume, preferred loans, etc.) and focus their efforts accordingly.

In practice, however, identifying such dealers is difficult because the necessary information is not available in a digital format that is convenient or effective for processing. These inefficiencies may render it more difficult for the sales representative to use existing systems to consistently satisfy sales protocols and best practices, such as commitments received, time spent with customers, etc.

Moreover, there is, in general, a lack of technical features that provide other advantages that would be beneficial to individuals in the sales and customer service fields, such as quick and efficient production of relevant information, automatic determination of the most efficient use of a sales representative's time and effort, or assistance with organization and collaboration of a sales team.

Conventional systems not only lack functionality, but also are typically spread across multiple platforms that require the use of restricted network connections. As a result, integration of relevant information spread across the platforms is inefficient, difficult, or even impossible, requiring excess operator time and processing resources.

The present disclosure is directed at overcoming one or more of the shortcomings set forth above and/or other problems of existing hardware systems.

### SUMMARY

The disclosed embodiments include a device or devices that are configured to provide one or more planning and analytics tools to a user.

In one aspect, the present disclosure is directed to an operations management device. In another aspect, the present disclosure is directed to a planning system for a sales representative. In yet another aspect, the present disclosure is directed to a team communication system for a sales team.

In one embodiment, an automated computing device for providing a planning and analytics tool is disclosed. The automated computing device includes a reports module configured to receive a data request for activity data associated with a plurality of dealers, locate and retrieve data corresponding to the request, and provide the data corresponding to the request to a client device. The automated computing device further includes a planning module configured to receive the activity data, identify at least one task for a user to complete based on the activity data, and provide the identified at least one task to the client device.

In another embodiment, an automated computing device for a sales representative is disclosed. The automated computing device includes a planning module configured to receive a selected factor associated with dealers, identify a plurality of dealers that correspond to the selected factor, determine a rating for each of the plurality of dealers according to the selected factor, and provide the identified dealers and the ratings to a client device.

In still another embodiment, a team communication system for a sales team is disclosed. The team communications system includes a communications module configured to receive a location of a user based on a location of a first client device, identify a task to be completed based on the location, select a second client device based on the identified task, and send an indication of the location to the second client device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments;

FIG. 2 is a block diagram of an exemplary computing device, consistent with disclosed embodiments;

FIG. 3 is a block diagram of another exemplary system, consistent with disclosed embodiments;

FIG. 4 is a block diagram of an exemplary user interface including a planning and analytics tools dashboard, consistent with disclosed embodiments;

FIG. 5 is a flowchart of an exemplary data viewing and report generation process, consistent with disclosed embodiments;

FIG. 6 is a block diagram of an exemplary user interface associated with a data and report viewing function, consistent with disclosed embodiments;

FIG. 7 is a flowchart of an exemplary goal setting/tracking process, consistent with disclosed embodiments;

FIG. 8 is a block diagram of an exemplary user interface associated with a goal setting/tracking function, consistent with disclosed embodiments;

FIG. 9 is a flowchart of an exemplary automated planning process, consistent with disclosed embodiments;

FIG. 10 is a flowchart of an exemplary customized mapping and routing process, consistent with disclosed embodiments;

FIG. 11 is a block diagram of an exemplary user interface associated with a mapping/routing function, consistent with disclosed embodiments;

FIG. 12 is a block diagram of an exemplary user interface associated with a group communication function, consistent with disclosed embodiments; and

FIG. 13 is a flowchart of an exemplary integrated user location and group communication process, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

Disclosed embodiments generally pertain to a comprehensive system that includes a variety of technical features to guide sales representatives and associated individuals on best practices, sales protocol, and efficient use of time and resources. Disclosed embodiments may be particularly applicable to the field of financial service sales, such as sales related to automobile dealerships and automobile financing. For example, a disclosed planning and analytics tool may provide sales representatives and sales managers with a variety of previously unavailable resources and tools that enable the users to efficiently and effectively come to commitment agreements with dealers and provide customer service to approve, negotiate, and/or service loans for end-user customers (e.g., car-buyers).

In addition, the disclosed embodiments provide a complete, comprehensive system that is accessible from one location and in a mobile environment. Previous systems not only lacked functionality, but also were spread across multiple platforms and required the use of restricted network connections due to a lack of resources having authorized access to relevant information.

Further, the disclosed embodiments provide additional innovative technical features that allow for automated planning based on data analysis and selected criteria. These features may provide sales representatives with features such as automatically generated daily schedules with tasks that are customized to include the most beneficial opportunities for sales and/or customer service. Further functionality may include automatically mapping and routing a schedule in order to provide the most efficient driving route for the user to utilize, thereby further reducing time wasted and improving efficiency.

The disclosed embodiments are generally described in relation to financial sales, and, in particular, dealings between sales representatives for financial service providers and dealers, such as automobile dealerships. It should be understood, however, that there are other fields, such as other sales and customer service environments, that may benefit from one or more of the features described herein, and it is contemplated that the features could be applied to other fields in some embodiments.

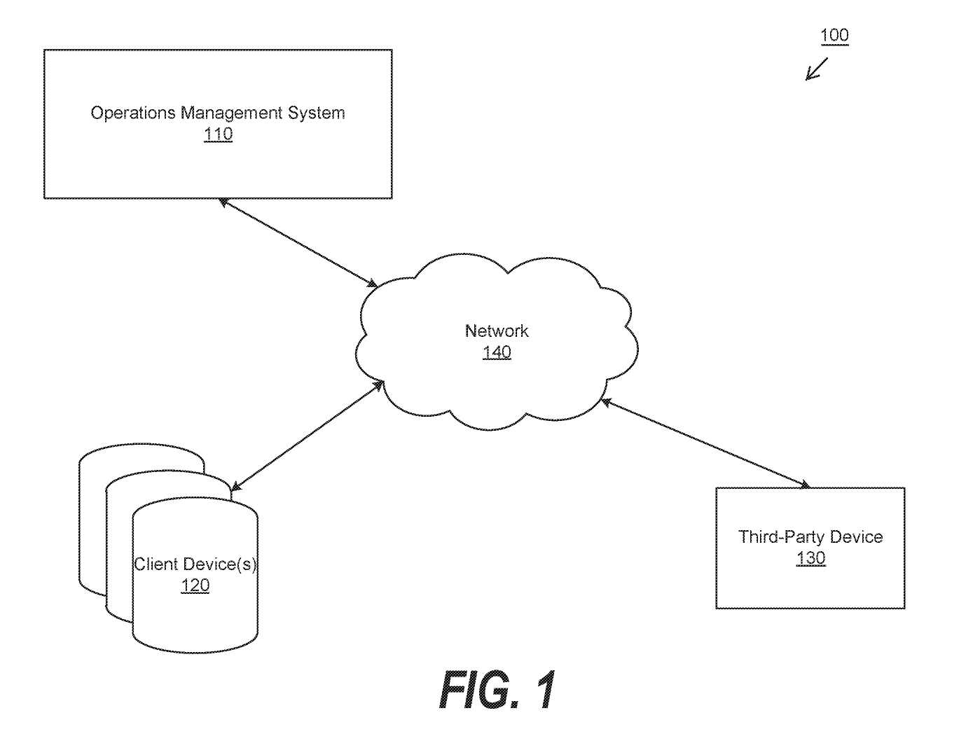

FIG. 1 is a diagram illustrating an exemplary system 100 for performing one or more operations consistent with the disclosed embodiments. In one embodiment, system 100 may include an interconnected plurality of systems and devices configured to provide the features described herein. For example, system 100 may include at least an operations management (OM) system 110, a plurality of client devices 120, a third-party device 130, and a network 140. The components and arrangement of the components included in the system 100 may vary. Thus, the system 100 may further include other components that perform or assist in the performance of one or more processes consistent with the disclosed embodiments.

OM system 110 may include one or more computing systems that are configured to execute software instructions stored on one or more memory devices to perform one or more operations consistent with the disclosed embodiments. OM system 110 may include one or more of a server, a computer, an embedded system, or a dedicated hardware device. In certain embodiments, OM system 110 may be configured as a particular apparatus, system, and the like based on the storage, execution, and/or implementation of the software instructions that perform one or more operations consistent with the disclosed embodiments.

In an exemplary embodiment, OM system 110 may include hardware and/or software components configured to create, store, and transmit a variety of planning and analytics tools, such as tools that assist an individual in the field of sales with specialized tasks such as goal-setting, daily planning, team management, and opportunity recognition. For example, OM system 110 may include a plurality of hardware devices that are particularly configured to handle requests for information or selected services and/or to automatically identify and present relevant information and interactions that provide an individual with a distinct advantage over individuals relying on prior systems and methods.

OM system 110 may provide one or more of the planning and analytics tools described herein through, for example, an interactive website and/or mobile application. One or more hardware components of OM system 110, client device(s) 120, and one or more third-party devices 130 may communicate with each other via network 140 in order to carry out the steps of a process by which OM system determines and provides a requested tool. Hardware components may communicate via wireless or wired connections, application programming interfaces (APIs), or other network protocol that allows OM system 110 to retrieve information that is requested and/or necessary for the determination of information that is requested, regardless of the storage location of the information. Further, the configuration of system 100 may allow OM system 110 to maintain distinct profiles that allow for synchronization of up-to-date information across multiple devices.

Each client device 120 may be one or more computing systems that are configured to execute software instructions for performing one or more operations consistent with the disclosed embodiments. In some embodiments, client device 120 may be one or more of a mobile device (e.g., a tablet, smartphone, etc.), a laptop, a desktop computer, a server, an embedded system, a dedicated hardware device, etc. Client device 120 may include one or more processors configured to execute software instructions stored in memory, such as memory included in client device 120. Client device 120 may include software that, when executed by a processor, performs known network-related communication and content display processes. For instance, client device 120 may execute browser software that generates and displays interface screens including content on interface hardware (e.g., a display device) included in, or connected to, client device 120.

In one embodiment, client device 120 may be a laptop or desktop computer or mobile device (e.g., smartphone or tablet) configured to communicate with OM system 110 (e.g., via network 140). Client device 120 may be configured to execute software instructions to display an operations management portal generated by OM system 110. In one embodiment, the operations management portal may be a web-based application (e.g., website, application, widget, API, etc.) through which client device 120 may provide information to a user (e.g., information collected by OM system 110) and request information from OM system 110 (e.g., a particular planning and analytics tool available via the operations management dashboard).

Third-party device 130 may be one or more computing systems associated with a third-party. Third-party device 130 may include one or more computing systems that are configured to execute software instructions for performing one or more operations consistent with the disclosed embodiments. For example, third-party device 130 may be a server, computer, laptop, mobile device (e.g., tablet, smartphone, etc.), an embedded system, a dedicated hardware device, etc. While one third-party device 130 is shown in FIG. 1, it should be understood that system 100 may include a plurality of third-party devices 130, each associated with the same or different third-parties.

In one aspect, third-party device 130 may be associated with a third-party that determines, collects, and/or stores information related to financial service sales. For example, third-party device 130 may be associated with a financial service provider, insurance provider, loan servicers, automobile dealership, etc. Third-party device 130 may alternatively or additionally be associated with other service providers, such as social media networks, email services, mapping services, etc. OM system 110 may be configured to communicate with third-party device 130 to request and obtain information that may be used by OM system 110 to provide a requested service. For example, third-party device 130 may be a financial service provider device configured to provide financial information (e.g., associated with individuals, dealerships, etc.) to OM system 110. OM system 110 may use received information to create a report, graphic, schedule, prediction, etc. More generally, OM system 110 may use information received from a third-party device 130 in the providing of a planning and analytics tool through the operations management portal.

In another aspect, one or more of OM system 110 and client device 120 may provide information to third-party device 130. For example, third-party device 130 may integrate sales planning and analytics data and/or services into a third-party system and/or service. For example, third-party device 130 may be a schedule organizer and may receive daily planning information to update a calendar. In another example, third-party device 130 may be a social media platform configured to receive information from OM system 110 and/or client device 120, such as postings, messages, locations, graphics, reports, etc.

Network 140 may be any type of network configured to provide communications between components of system 100. For example, network 140 may be any type of network (including infrastructure) that provides communications, exchanges information, and/or facilitates the exchange of information, such as the Internet, a Local Area Network, Near Field Communication (NFC), WIFI, Bluetooth®, or other suitable connection(s) that enables the sending and receiving of information between the components of system 100. In other embodiments, one or more components of system 100 may communicate directly through a dedicated communication link(s) (not shown), such as a link between OM system 110 and client device 120.

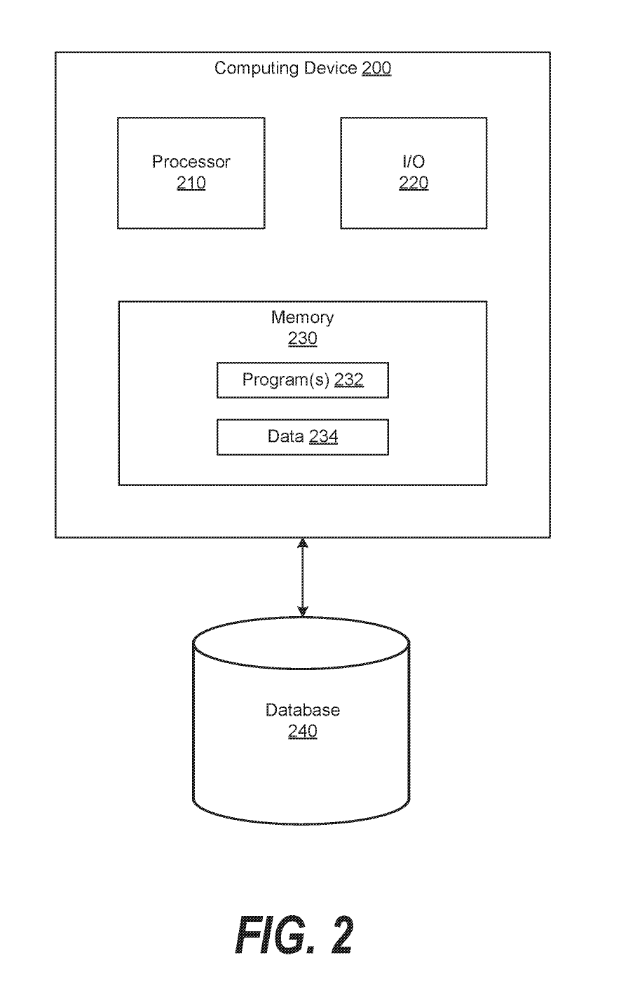

FIG. 2 shows an exemplary computing device 200 for implementing embodiments consistent with the present disclosure. In an exemplary embodiment, computing device 200 may correspond to OM system 110 (or a component thereof). It should be understood, however, that variations of computing device 200 may correspond to client device 120, third-party device 130, and/or components thereof.

In one embodiment, computing device 200 may include one or more processors 210, and one or more input/output (I/O) devices 220, and one or memory devices 230. According to some embodiments, computing device 200 may be an embedded system or similar computing device(s) that generate, maintain, and provide web site(s) and/or mobile applications consistent with disclosed embodiments. Computing device 200 may be standalone, or it may be part of a subsystem, which may be part of a larger system. For example, computing device 200 may represent distributed servers that are remotely located and communicate over a network (e.g., network 140) or a dedicated network, such as a LAN.

Processor 210 may include one or more known processing devices, such as a microprocessor from the Pentium™ or Xeon™ family manufactured by Intel™, the Turion™ family manufactured by AMD™, the “Ax” or “Sx” family manufactured by Apple™, or any of various processors manufactured by Sun Microsystems. The disclosed embodiments are not limited to any type of processor(s) configured in computing device 200. It should be understood, however, that processor 210, in some embodiments, may be particularly adapted and configured to perform steps related to the systems and methods disclosed herein. For example, processor 210 may include an ability to handle large volumes of processing requests over relatively short periods, such as what may be necessary for processing large amounts of financial service provider data.

I/O devices 220 may be one or more devices configured to allow data to be received and/or transmitted by computing device 200. I/O devices 220 may include one or more digital and/or analog communication devices that allow computing device 200 to communicate with other machines and devices, such as other components of system 100. In some embodiments, I/O devices 220 may include one or more interface hardware devices configured to present content such as websites and mobile applications, dashboards, and other user interface items.

Memory 230 may include one or more storage devices configured to store instructions used by processor 210 to perform functions related to disclosed embodiments. For example, memory 230 may be configured with one or more software instructions, such as program(s) 232 that may perform one or more operations when executed by processor 210. The disclosed embodiments are not limited to separate programs or computers configured to perform dedicated tasks. For example, memory 230 may include a single program 232 that performs the functions of the computing device 200, or program 232 could comprise multiple programs. Additionally, processor 210 may execute one or more programs located remotely from computing device 200. For example, OM system 110, client device 120, and/or third-party device 130, may, via computing device 200, access one or more remote programs that, when executed, perform functions related to certain disclosed embodiments. Memory 230 may also store data 234 that may reflect any type of information in any format that the system may use to perform operations consistent with the disclosed embodiments.

Computing device 200 may also be communicatively connected to one or more database(s) 240. Computing device 200 may be communicatively connected to database(s) 240 through network 140. Database 240 may include one or more memory devices that store information and are accessed and/or managed through computing device 200. By way of example, database(s) 240 may include MS SQL™, Oracle™ databases, Sybase™ databases, or other relational databases or non-relational databases, such as Hadoop sequence files, HBase™, or Cassandra™. The databases or other files may include, for example, data and information related to the source and destination of a network request, the data contained in the request, etc. Systems and methods of disclosed embodiments, however, are not limited to separate databases. In one aspect, computing device 200 may include database 240. Alternatively, database 240 may be located remotely from computing device 200. Database 240 may include computing components (e.g., database management system, database server, etc.) configured to receive and process requests for data stored in memory devices of database(s) 240 and to provide data from database 240.

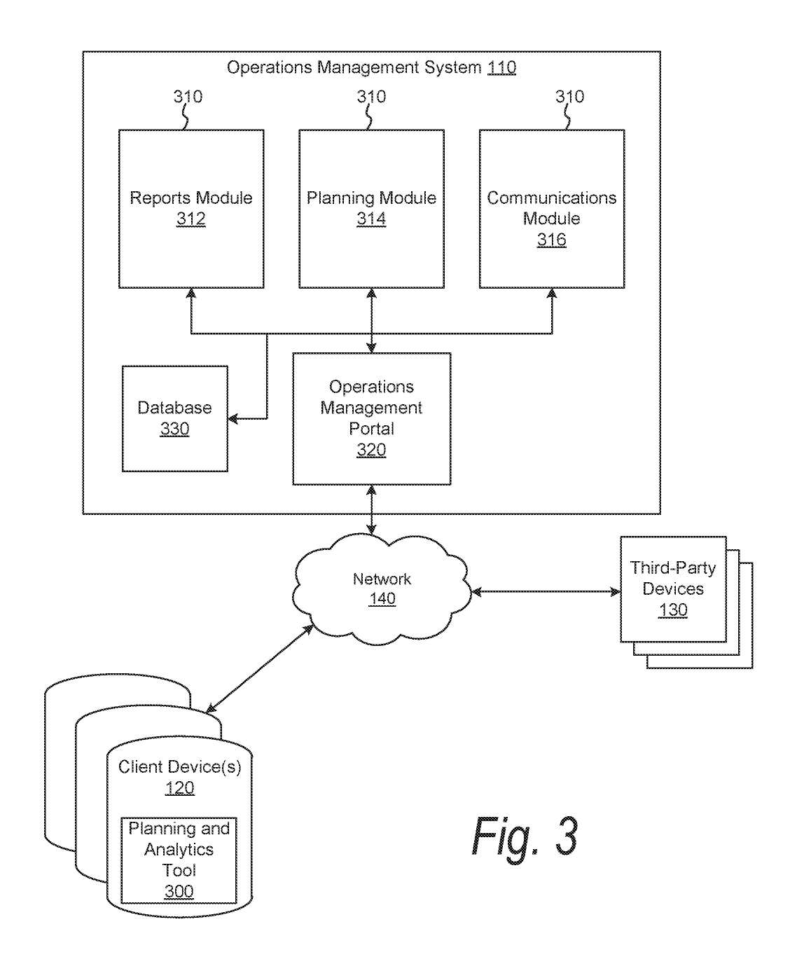

FIG. 3 is a diagram illustrating an exemplary configuration of the components of system 100, including various additional components and features thereof. It should be understood that the configuration of system 100 depicted in FIG. 3 is exemplary, and that other configurations, including additional and/or alternative components and features are possible.

In an exemplary embodiment, OM system 110 may include features configured to perform a variety of tasks in conjunction with providing a comprehensive planning and analytics tool 300 to one or more of client devices 120. For example, OM system 110 may include a plurality of modules 310, an operations management (OM) portal 320, and at least one database 330.

As shown in FIG. 3, client device 120 may include or embody one or more of a plurality of client devices 120. Client devices 120 may include devices operated by users. The users may operate client devices 120 to cause client devices 120 to communicate with OM system 110 via OM portal 320 and/or third-party devices 130 (e.g., through network 140). Client devices 120 may receive information from OM system 110 and/or third-party devices 130 and display it with associated interface hardware. Further, client devices 120 may be configured to receive user input, and provide the user input information to OM system 110 and/or third-party devices 130, such as to cause those devices to provide certain information back to client devices 120.

In an exemplary embodiment, client devices 120 may be configured to receive planning and analytics tool (PAT) 300 from OM system 100 via OM portal 320. For example, PAT 300 may be a mobile application for a mobile device, such as a tablet. In another embodiment, PAT 300 may be a website accessible via the Internet. Client devices 120 may receive information from OM system 100 to establish PAT 300. For example, client devices 120 may download a mobile application via OM portal 320 (or a third-party device 130 (e.g., app store)). During use, OM system 100 may communicate with client device(s) 120 to provide information and services through PAT 300. Information associated with PAT 300 may be stored locally on client device 120 or may be transmitted to client device 120 via OM portal 320 in real-time when requested. While PAT 300 is shown as a component of client device 120, it should be understood that PAT 300 may be a component of another device in system 100, such as OM system 100 or a third-party device 130.

Third-party devices 130 may be connected to network 140 such that third-party devices 130 may communicate with OM system 110 (e.g., via OM portal 320) and/or client devices 120 (e.g., indirectly via OM system 110 or directly via network 140). As shown in FIG. 3, third-party devices 130 may include a plurality of third-party devices 130, which each may be associated with a different third-party entity. In one aspect, some third-party devices 130 may track and store information that is convenient for OM system 110 to use, but that is not necessarily gathered for the sole purpose of its use with OM system 110 and PAT 300. For example, third-party devices 130 may include a mapping service configured to provide information regarding the relative location of places and roads. In another example, a third-party device 130 may be a dedicated device configured to track and store information for use by OM system 110, such as a financial service sales data collection device.

Modules 310 may serve as data sources, configured to collect and store information, as well as to generate and store additional information and/or customized tools. In an exemplary embodiment, modules 310 may include at least a reports module 312, a planning module 314, and a communications module 316. For the purposes of this disclosure, each “module” (also known as “engines”) may be implemented in software, hardware, firmware, and/or a combination thereof. For example, if the disclosed “modules” are implemented in software, they may be stored in a memory associated with OM system 110. Processors, I/O devices, and memory devices may be utilized to perform processes to implement and facilitate operations of modules 310. Thus, modules 310 may include code instructions executable by one or more processors, alone or in various combinations with other modules disclosed in this or other embodiments. For example, reports module 312 may be configured to interact with planning module 314, and/or other modules of OM system 110, shown or not shown in FIG. 3, to perform functions consistent with disclosed embodiments. In other embodiments, if the disclosed “modules” are implemented in hardware, they may comprise an embedded system or other dedicated hardware configured by machine code, assembly code, or the like to interact with other modules of OM system 110 to perform functions consistent with disclosed embodiments.

Reports module 312 may be configured to track, store, and/or provide information that may be used in providing PAT 300. For example, reports module 312 may be configured to perform the steps of one or more processes to generate a report that includes requested information presented in a selected form. For example, reports module 312 may receive a request for a report from client device 120 via OM portal 320, gather information needed for the report, generate the report based on the gathered information, and provide the report to client device 120 via OM portal 320. Client device 120 may provide the report to a user via PAT 300.

In an exemplary embodiment, reports module 312 may be configured to manage information associated with sales, and, in particular, financial service sales. For example, reports module 312 may be configured to track, store, and/or provide information associated with financing, such as automobile financing. This information may include, for example, immediate customer (e.g., automobile dealership) information, end-user customer (e.g., car-buyer, car-leaser, etc.) information, financial service provider information (e.g., previous loans, current rates, financing terms, etc.), and the like.

Reports module 312 may be configured to communicate with third-party devices 130 in order to receive information that may be provided in a selected report. For example, reports module 312 may be configured to communicate with a third-party automobile dealership to request and receive information such as financing data, inventory information, dealer descriptions, vehicle sales employee data, etc. Further, reports module 312 may be configured to communicate with client device 120 (e.g., via OM portal 320) to send and receive information, including requests for a report and completed reports.

Planning module 314 may be configured to utilize information to automatically identify tasks for a user to complete. For example, planning module 314 may perform the steps of one or more processes to identify potential actions that relate to selected criteria, such as projected profit, customer service needs, market demands, territory coverage, and the like. For example, planning module 314 may identify which dealers a sales representative should visit in a given day based on criteria such as which dealers are likely to complete the most favorable loans.

In addition to daily planning functionality, planning module 314 may also provide long-term planning options that may provide organizational advantages to a user. For example, planning module 314 may provide goal setting and tracking functions that allow a user and/or a group of users to set and track goals associated with their day to day and long-term tasks and activities. For example, planning module 314 may allow a user to set goals related to tasks such as dealer commitments, customers acquired, loans serviced, etc.

OM portal 320 may be an exemplary interface through which OM system 110 may communicate with client device 120 and third-party devices 130. While OM portal 320 is depicted and described as one interface, it should be understood that OM portal 320 may include a plurality of interfaces, such as an internal OM portal for communicating with client device 120 (e.g., through a website or mobile application associated with OM system 110) and an external OM portal for communicating with client device 120 (e.g., through a third-party website or mobile application) and/or third-party device 130.

In addition to modules 310, OM system 110 may include or be connected to at least one database 330. Database 330 may contain relevant information that may be used by one or more components of system 100, such as any of modules 310. One or more of modules 310 may be configured to retrieve information from database 330 for use in a selected process. In some embodiments, client device(s) 120 and/or third-party device(s) 130 may be configured to retrieve information from database 330 (e.g., via OM portal 320 and/or network 140.

In an exemplary embodiment, database 330 may be a user database configured to receive, store, and provide information associated with a team of sales representatives, sales managers, and associated individuals. For example, database 330 may store user profiles associated with users of client devices 120. Each user profile may include information associated with the user, such as user login information, performance data, goal data, scheduling data, location history, etc. In this way, database 330 may serve as a repository for pertinent and non-pertinent information associated with a sales team. As a result, OM system 110 may be configured synchronize personal information over multiple devices, as well as enable group communication functionality, including integrated and automated functions based on user activities and/or locations.

Dashboard

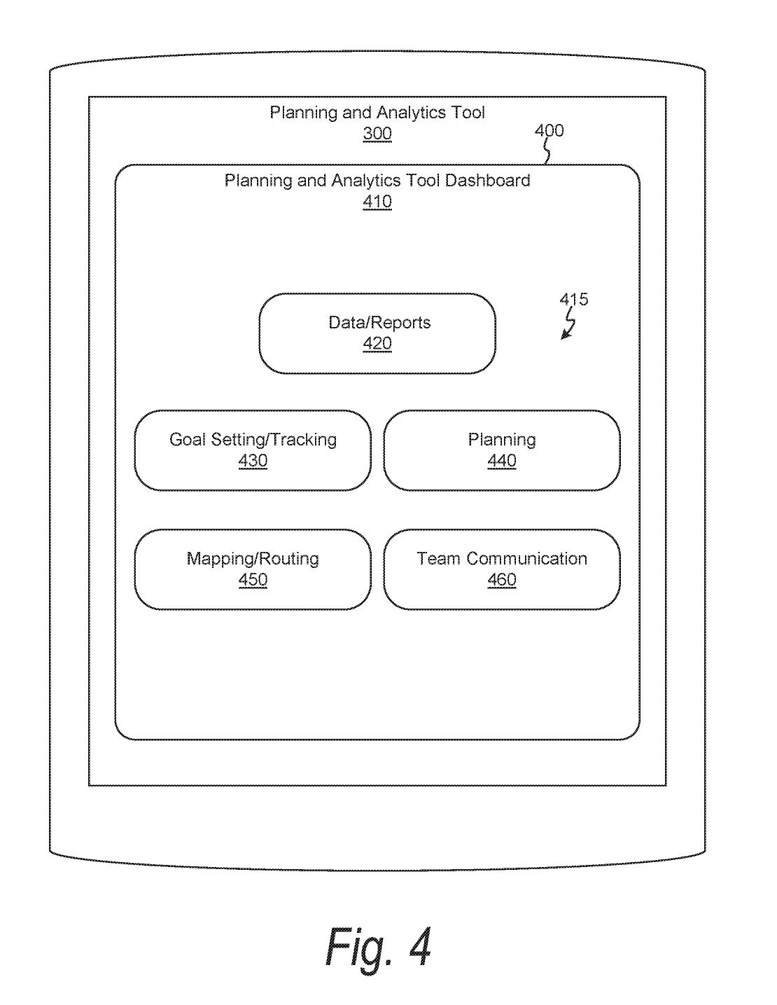

FIG. 4 is a block diagram of an exemplary user interface 400, consistent with disclosed embodiments. In an exemplary embodiment, client device 120 may display user interface 400 as part of planning and analytics tool 300 using interface hardware. User interface 400 may include a planning and analytics tool dashboard (dashboard) 410. Dashboard 410 may provide a central location for planning and analytics tool 300 to provide one or more sub-tools to a user of client device 120. For example, dashboard 410 may include a menu-type selection of a plurality of sub-tools 415.

In one embodiment, sub-tools 415 may include a data/reports sub-tool 420, a goal setting/tracking sub-tool 430, a planning sub-tool 440, a mapping/routing sub-tool 450, and a team communication sub-tool 460. It should be understood that these sub-tools are exemplary and that additional or alternative sub-tools or other functionalities may be provided as part of dashboard 410. It should also be understood that the presentation of sub-tools 415 may be configured in any manner (i.e., not necessarily in the form of a menu).

Each sub-tool 415 may be a selectable electronic program that, when selected, may cause planning and analytics tool 300 to provide information and/or services associated with the selected sub-tool. For example, selection of data/reports sub-tool 420 may cause client device 120 to communicate with OM system 100 in order to provide requested data or reports.

Data and Reports

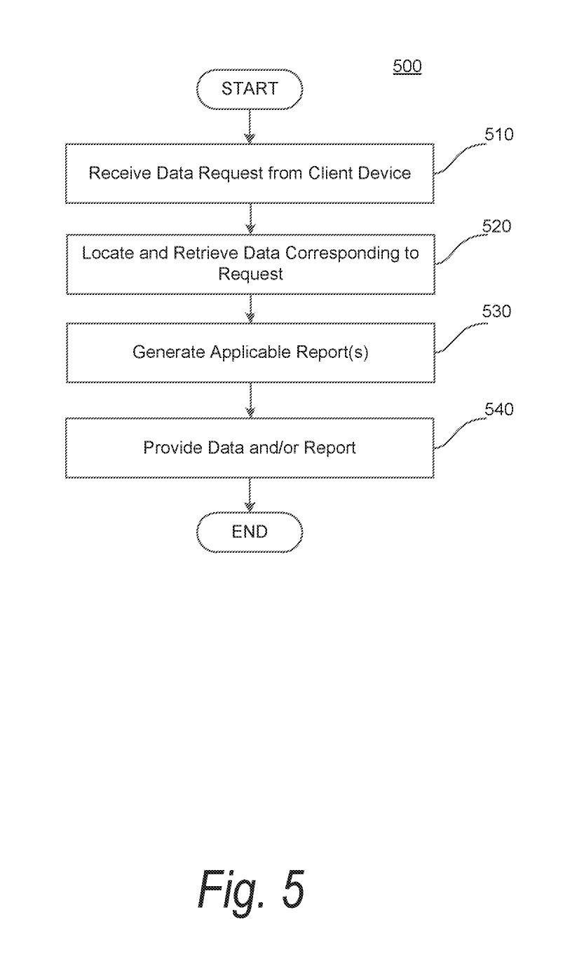

In an exemplary embodiment, planning and analytics tool 300 may include a feature that provides a convenient and efficient source of activity data (e.g., sales data) capable of being retrieved, searched, sorted, filtered, and displayed by one or more components of system 100. FIG. 5 is a flowchart of an exemplary process 500 for providing data and/or a data report, consistent with disclosed embodiments.

In step 510 of process 500, OM system 110 may receive a data request from client device 120. For example, OM system 110 may receive a data request at reports module 312. The data request may reflect a user's request for information made using interface hardware associated with client device 120. For example, a user may request a report of all loans made at dealers within a certain area (e.g., territory, zip code, city, etc.). Reports module 312 may receive the data request through OM portal 320.

In step 520, OM system 110 may locate and retrieve data corresponding to the data request. For example, reports module 312 may determine a location of data necessary to fulfill the request and retrieve the data from the determined location. Reports module 312 may be configured to communicate with any component of system 100 to retrieve requested information. For example, reports module 312 may request and receive data from one or more of database 330, a third-party device 130, a client device 120, planning module 314, communications module 316, or another component of system 100.

In step 530, OM system 110 may generate any applicable report(s) containing the located and retrieved data. For example, reports module 312 may execute a program to analyze the data request and the retrieved data to determine the form and/or content of a report for providing the data. As used herein a “data report” may refer to the form in which planning and analytics tool 300 provides the data. For example, spreadsheets, graphs, charts, listings, etc., may all be considered data reports. A data report is an indication that provided information was requested and returned based on the request. For example, the data request may include search terms, filters, equations, etc., that may be used to identify the information (e.g., result) that is being sought. Reports module 312 may use the information in the data request to generate the data report. Further, the data request may include a report type indication, which may indicate the manner in which the report should be organized and/or presented.

In step 540, OM system 110 may provide the data and/or generated report to client device 120. For example, reports module 312 may transmit the data and/or report to client device 120 through OM portal 320. Client device 120 may receive the data and/or report and perform one or more processes to display the received information.

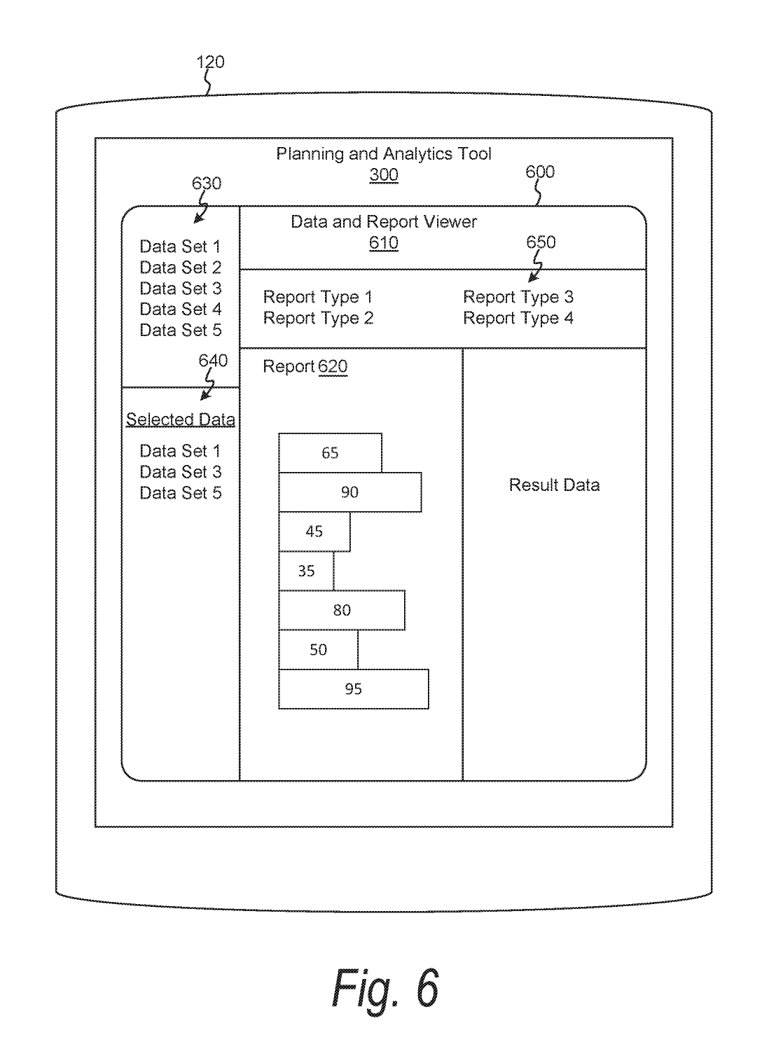

FIG. 6 is a block diagram of an exemplary user interface 600, consistent with disclosed embodiments. In one embodiment, user interface 600 may be associated with data/reports sub-tool 420. For example, selection of data/reports sub-tool 420 (and, in some instances, one or more additional steps, such as data and report selection) may cause OM system 110 to perform process 500, which may result in client device 120 displaying a data and report viewer 610 via user interface 600.

User interface 600 may display data and report viewer 610 such that a user may view requested information associated with financial service sales and/or customer service. For example, as shown in FIG. 6, a user may provide input to user interface 600 to generate a report 620. In an exemplary embodiment, user interface 600 may provide a plurality of data set options 630, of which a user may select a subset 640. The data sets may include categories of information, such as names, dates, areas, financial services, case statuses, dealer information, performance data, etc. In some embodiments, user interface 600 may further include a report type selection 650, which may further indicate the manner in which the requested data may be presented.

Report 620 may include various graphical features, such as graphs, charts, diagrams, etc. Report 620 may include a listing of result data when appropriate. For example, client device 120 may request a report of a list of group members and the number of sales agreements (e.g., commitments) that the each group member has completed over a selected time period. OM system 110 may perform one or more processes (e.g., process 500) to retrieve the list of group member names and determine the number of sale agreements they have completed, filtered by the selected time period. OM system 110 may generate report 620, which may include a bar graph that shows the relative performance of group members, as well as an individualized data listing. It should be understood that the configuration of data and report viewer 610 is exemplary and that other configuration are possible.

The data/reports sub-tool 420 may provide users with a convenient and powerful tool to quickly and easily view information that is useful in researching and planning sales tasks, activities, and strategies. For example, providing access to multiple third-party devices 130 as well as a network of client devices 120 places OM system 100 among a plurality of useful sources of information, such as dealer systems, other financial service provider systems, activity data (e.g., sales data), best practice information, and the like. The availability of this information in one location provides users with an efficient tool for finding information quickly and easily.

Goal Setting and Tracking

In an exemplary embodiment, planning and analytics tool 300 may also include a feature that allows for quick and easy goal setting and tracking. The feature may work on an individual-level to keep track of individual goals for a user, as well as on a group-level to track the performance of an overall unit or group of individuals (e.g., for a sales manager to review group performance). In addition, the feature may allow OM system 110, or another component of system 100, to automatically determine goals for an individual or group and present those goals to a user.

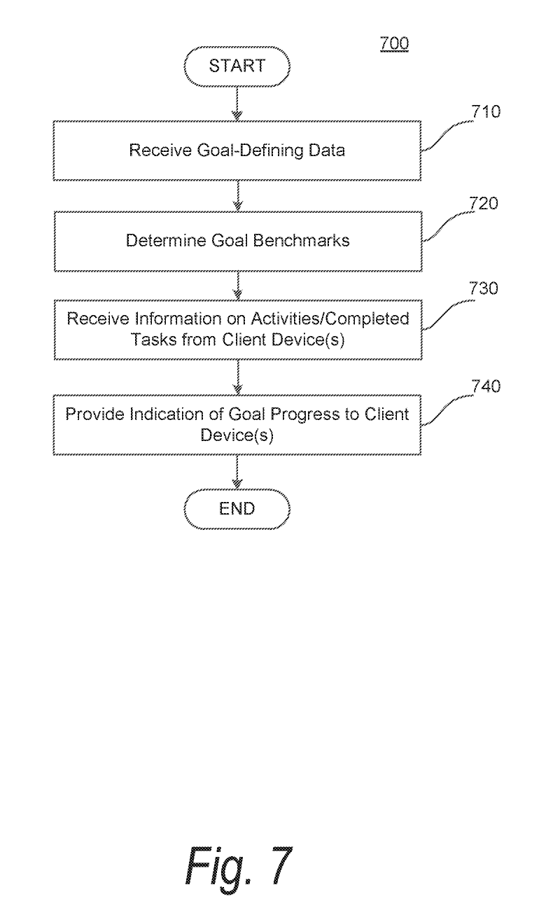

FIG. 7 is a flowchart of an exemplary process 700 for a goal setting and tracking process, consistent with disclosed embodiments.

In step 710, OM system 110 may receive goal-defining information, such as performance parameters, company protocol and procedures, best practices, historical performance data, and the like. For example, OM system 110 may store such information in database 330 and/or may access such information from client device(s) 120 and/or third-party device(s) 130 via network 140. In one embodiment, planning module 314 may receive the information. In other embodiments, another component of system 100, such reports module 312, may receive the goal-defining information.

In step 720, OM system 110 may determine goal benchmarks. For example, planning module 314 may identify values that define a particular goal. For instance, planning module 315 may identify numerical values for each goal, and set those numerical values as the benchmarks to which to compare performance data. Examples of goals that may include such benchmarks include total sales, dealer commitments, total loan amounts, loan volume, dealer visits, dealer performance values, etc.

In one embodiment, planning module 314 may receive a goal benchmark as input from a user. For example, a user (e.g., a sales manager) may identify particular benchmarks that correspond to team goals, bonus levels, performance standards, etc. In another embodiment, planning module 314 may automatically determine a goal benchmark based on the received goal-defining information. For example, planning module 314 may set a company protocol value as a benchmark. In another example, planning module 314 may review information such as past performance data, market predictions, company growth, etc., and determine a value for a benchmark goal that corresponds to performance expectations.

In step 730, OM system 110 may receive information regarding user activity and completed tasks. For example, planning module 314 (and/or reports module 312) may receive user activity information from client device(s) 120. In one embodiment, client device 120 may track information such as user location, sales information, dealer visits and communications, etc. Client device 120 may provide the tracked information to planning module 314 via network 140. In some embodiments, OM system 110 may receive activity information from third-party devices 130. For example, planning module 314 may retrieve completed sales information from a dealer system.

In step 740, OM system 110 may provide an indication of goal progress. For example, planning module 314 may track and provide goal progress information to client device 120. The indication may include, for example, graphics and/or other visualizations that clearly identify a user's progress toward or completion of a goal. Client device 120 may receive information that may be used to display the indication of goal progress using interface hardware.

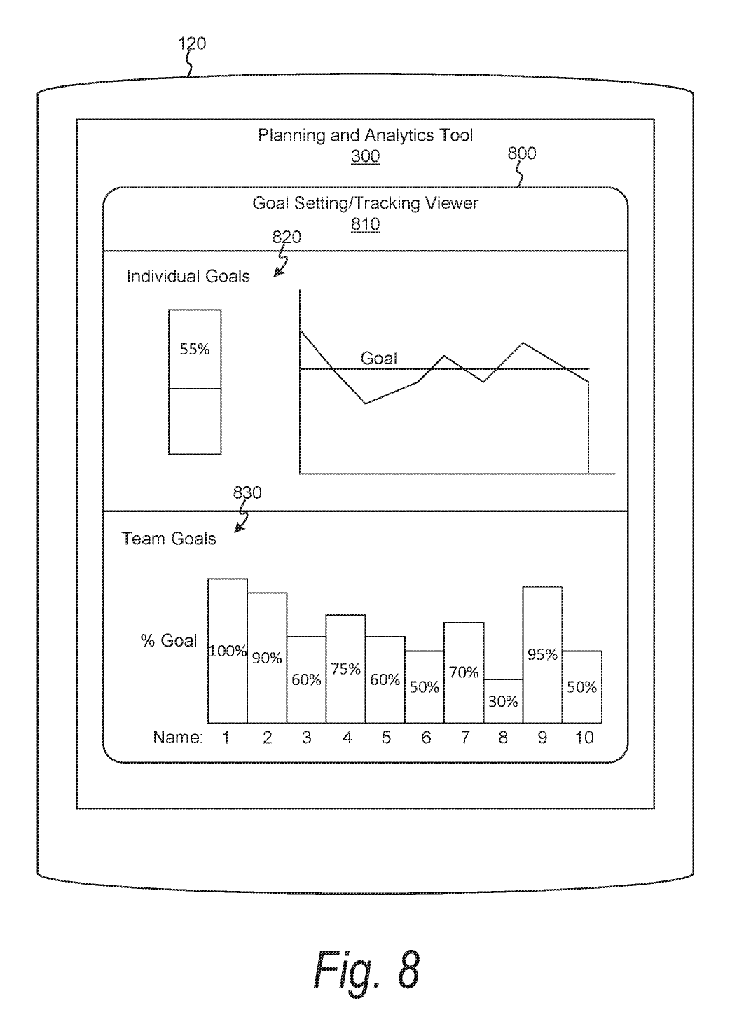

FIG. 8 is a block diagram of an exemplary user interface 800, consistent with disclosed embodiments. In one embodiment, user interface 800 may be associated with goal setting/tracking sub-tool 430. For example, selection of goal setting/tracking sub-tool 430 (and, in some instances, one or more additional steps, such as the receipt of additional goal-related information) may cause OM system 110 to perform process 700, which may result in client device 120 displaying a user's progress towards selected goals.

In an exemplary embodiment, user interface 800 may be configured to display a goal setting/tracking viewer 810 as part of planning and analytics tool 300. Goal setting/tracking viewer 810 may include display features that provide a user with a clear and concise depiction of their performance in relation to goal benchmarks. For example, goal setting/tracking viewer 810 may include charts, graphs, visualizations, etc., that provide an indication of an individual or group performance. As shown in FIG. 8, goal setting/tracking viewer 810 may include sections for individual goals 820 and/or group goals 830 (e.g., team or unit collective, collaborative, or competitive goals).

The goal setting/tracking sub-tool 430 may provide a user with an effective tool for tracking individual and group performance (e.g., in relation to others and/or to benchmarks). In the field of sales (e.g., financial service sales), these goals may help users evaluate their own and other's performance and identify strengths and weaknesses. Further, the use of goal setting/tracking sub-tool 430 in conjunction with the other features of the comprehensive PAT 300 allows for a wide range of possible instances of goal setting and tracking due to the integration with reports module 312 and connection to third-party devices 130 and client devices 120. In addition, the ability of planning module 314 (or another component of system 100) to identify expectations based on available information and automatically set benchmarks may provide users with fair, realistic, and effective goals that are based on values that will help the user and employing company.

Daily Planning

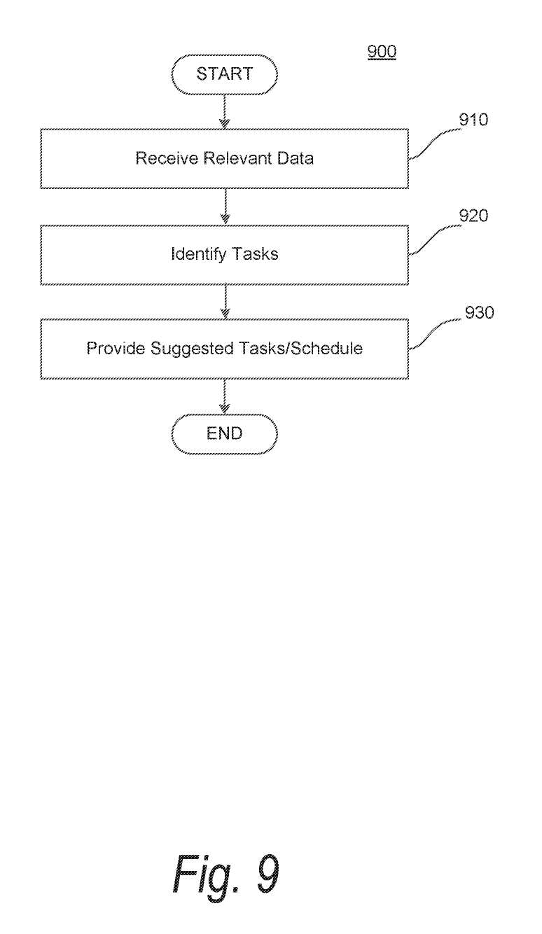

In an exemplary embodiment, PAT 300 may further include a feature that provides automated planning of tasks for a user, such as a sales representative user. For example, OM system 110 may, based on available information, identify one or more tasks that satisfy selected criteria for a user, thereby alleviating the need for the user to review information and plan tasks for a given day. FIG. 9 is a flowchart of an exemplary process 900 for providing a daily planning function, consistent with disclosed embodiments.

In step 910, OM system 110 may receive relevant data for providing the planning function. For example, planning module 314 may receive information such as dealer information, customer information, activity data such as performance data, sales data, and historical data, company procedures, best practices, individual and group goals, expectations, etc. Planning module 314 may receive relevant data from client devices 120 and/or third-party devices 130.

In step 920, OM system 110 may identify tasks for a user to complete. For example, planning module 314 may analyze available information to identify opportunities for an individual to complete tasks that are beneficial. For example, planning module 314 may identify a dealer that has sales potential and that has not been visited by a sales representative for a period of time. Planning module 314 may match this opportunity to goal or expectation information to determine that a user can further the goal or meet the expectation by achieving the task.

In step 930, OM system 110 may provide the identified task(s) to client device 120. For example, planning module 314 may provide suggested tasks to client device 120 via OM portal 320. Client device 120 may receive the suggested tasks and display the suggested tasks via interface hardware and PAT 300.

In some embodiments, client device 120 may provide one or more planning criteria that identify required or desired features of a task. For example, client device 120 may provide to planning module 314 an identification of a type of task (e.g., new dealer visit, existing customer visit, etc.), a particular area or timing of the task, or some other criteria that may help planning module 314 select between multiple possible tasks while taking into consideration certain features that are desired by the user.

In some embodiments, planning module 314 may identify a plurality of tasks that will be beneficial for a user to complete during a given day. Planning module 314 may further coordinate to assist the user in completing the tasks, such as by providing a schedule for the day for completing the tasks. For example, planning module 314 may provide a list of dealers to visit, scheduled times to visit the dealers, and tasks to be completed (or attempted) at each dealer while the user is present.

Consistent with disclosed embodiments, a user may access the planning function through PAT 300. For example, a user may select planning sub-tool 440 from dashboard 410. In response, client device 120 may, for example, cause OM system to complete one or more steps of process 900. For example, client device 120 may communicate with planning module 314 of OM system 110 to gather data and any planning criteria, identify potential tasks, and select tasks for the user to complete. Client device 120 may provide the selected tasks (e.g., in the form of a detailed direction, list, schedule, etc.) to client device 120, which may be displayed via interface hardware.

Planning sub-tool 440 may provide PAT 300 with a technical feature that allows for the automation of identifying particular tasks for an individual to complete during a day. Further, due to the comprehensiveness of PAT 300, even if OM system 110 does not suggest particular tasks for a user to complete, the user may be provided with quick and easy access to a wide array of tools and information that allow the user to identify beneficial tasks quickly and easily. For example, a user, through use of another function provided by PAT 300, may recognize particular areas of opportunity (e.g., undervalued areas, dealers, etc.) and identify tasks to be completed.

Mapping and Routing

Consistent with disclosed embodiments, OM system 110 may further include a mapping function for providing visualizations that may help a user identify beneficial sales and/or customer service opportunities. For example, reports module 312 (and/or planning module 314) may perform an automated process to produce a map indicating locations of entities (dealers, customers, competitors, etc.) that meet selected criteria. Selected criteria may include carefully selected filters that separate potential entities so that entities that may be of interest may be easily identified. In addition, OM system 110 may be configured to analyze data associated with the different entities (e.g., sales data) to determine a rating for each entity. The ratings may further provide a user with a visual indication on which it may be beneficial to focus their efforts.

In some embodiments, OM system 110 may be further configured to provide an automated routing function, which may be an additional efficiency tool that maps a route for a user to follow to complete suggested tasks (e.g., visit entity locations that satisfy selected criteria).

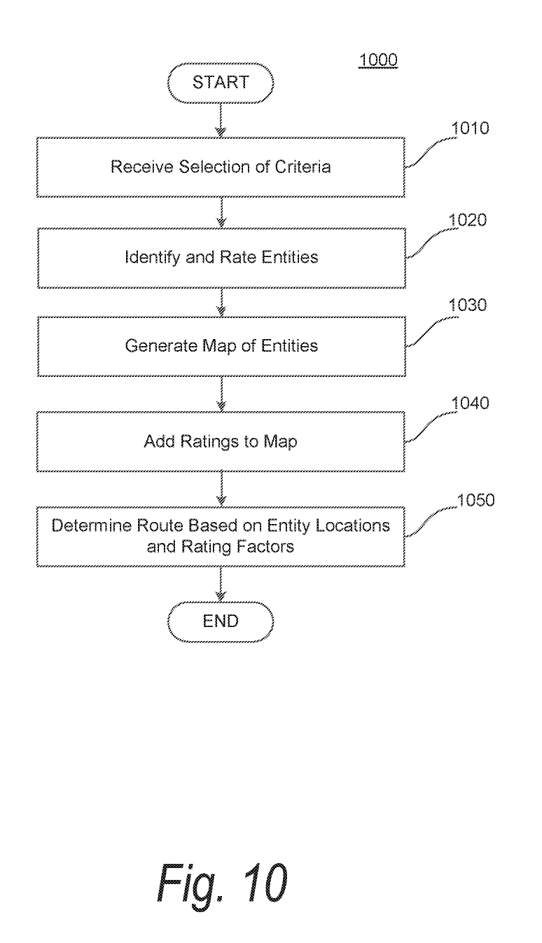

FIG. 10 is a flowchart of an exemplary process for providing a mapping and routing function, consistent with disclosed embodiments.

In step 1010, OM system 110 may receive a selection of criteria. The criteria may identify features of an entity (e.g., dealer) that both allows the entity to be identified and allows the entity to be assigned a rating associated with the criteria. For example, selected criteria may include, in relation to a dealer: an amount of competition for services, loan completion frequency, types of loans that are completed, inventory types, dealer location, etc. In one example, reports module 312 may receive selected criteria from client device 120, which may have been input by a user. The rating may be assigned by OM system 110 and/or by a third-party device 130 or other entity.

In step 1020, OM system 110 may identify and rate entities that correspond to the selected criteria. For example, if the selected criteria is/are the type(s) of loans that are completed, reports module 312 may identify dealers, thereby identifying entities that provide loans. Reports module 312 may also determine a rating for each entity according to the selected criteria. For example, reports module 312 may rate each dealer according to the types of loans that the dealer completes, such as by rating dealers that more often use and/or are more likely to use particular loan types (e.g., select loans for highly-qualified customers, high interest loans, low interest loans, loans in an amount above or below a threshold, etc.). The rating may include an associated value (e.g., a value from 1-10), a color code, and/or other feature that may be visually presented to display the rating.

In step 1030, OM system 110 may generate a map of the identified entities that correspond to the selected criteria. For example, reports module 312 may generate a map of dealers within a selected area (e.g., territory, zip code, city, etc.). In some embodiments, reports module 312 may communicate with a third-party device 130 (e.g., a device with mapping functionality) to generate the map.

In step 1040, OM system 110 may overlay or otherwise include the ratings for each mapped entity. For example, reports module 312 may include with the generated map an indicator of the rating of each entity. For instance, reports module 312 may include a numerical value, color coding, size coding, and/or a relative ranking with the generated map. The map, including identified dealers and associated ratings, may alone be a powerful tool for allowing a user to easily recognize dealers and areas that correspond to selected criteria and their relative rating within the selected criteria. This may clearly indicate to a user dealers and areas on which it may be beneficial to focus their efforts.

In the example where the selected criteria relates to the types of loans that the dealer completes, reports module 312 may generate a map that identifies and rates/ranks dealers within a selected area according to whether the dealers complete or are likely to complete certain loans. In this way, a user may identify dealers that potentially have the highest value (e.g., in terms of reaching goals for completing certain types of loans, receiving highest return on time investment, etc.), and choose to visit those dealers that day.

In some embodiments, OM system 110 may further modify the map to provide guidance to a user. For example, in step 1050, reports module 312 may determine a driving route between identified dealers. In some embodiments, reports module 312 may take into consideration the dealer rating such that the route prioritizes higher-rated dealers. For example, reports module 312 may map a route between dealers with a rating above a threshold. In this way, OM system 110 may provide an additional convenience to a user, thereby providing the user with a daily plan for visiting dealers. In some embodiments, the routing step may be optional, such that, in some instances, reports module 312 may generate a map with dealers and ratings and allow the user to determine which dealers to visit and a route to take. OM system 110 may provide a generated map to client device 120 (e.g., via OM portal 320), and client device 120 may display the map using interface hardware.

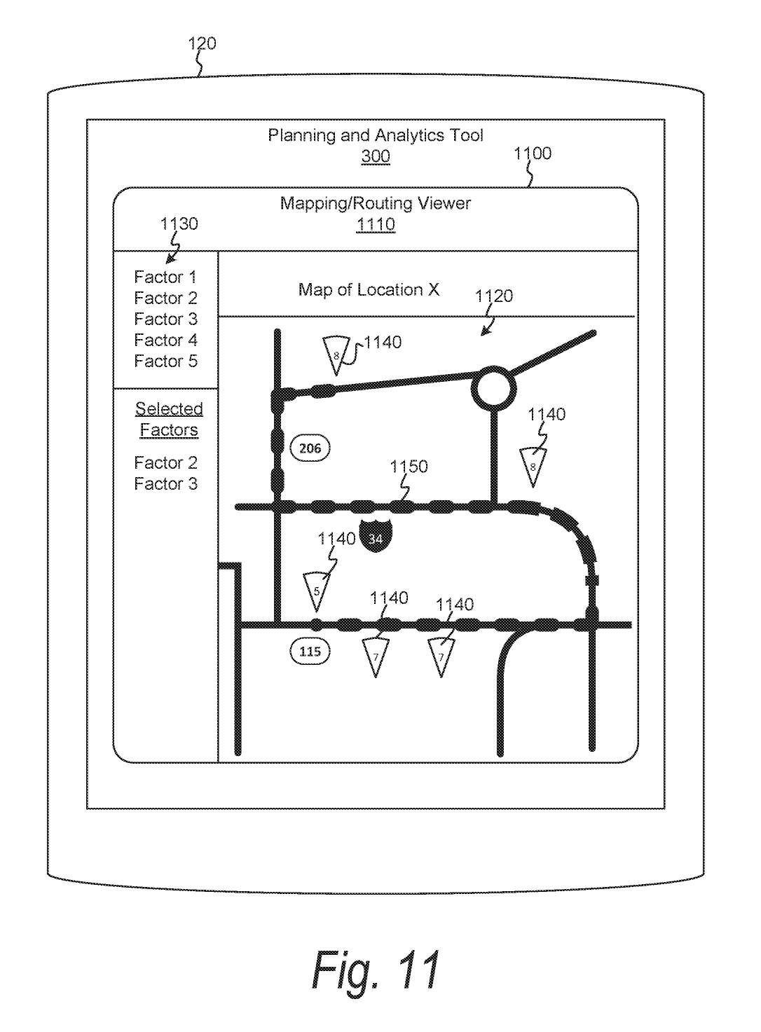

FIG. 11 is a block diagram of an exemplary user interface 1100, consistent with disclosed embodiments. In one embodiment, user interface 1100 includes a mapping/routing viewer 1110, which may be provided as part of PAT 300. Mapping/routing viewer 1110 may include a map 1120 that is generated using process 1000. In one example, a user may select mapping/routing sub-tool 450 from dashboard 410, which may cause client device 120 to display mapping/routing viewer 1110.

User interface 1100 may include an input region 1130 that may allow a user to select one or more factors that represent criteria for dealers to be identified in a generated map. For example, the one or more factors may include dealer segmentation factors (e.g., types of loans), dealer competition factors (e.g., number of financial service providers doing business in the area), dealership commitment or conversion rates, etc. As described above with respect to process 1000, OM system 110 may receive these rating factors and may use the selected criteria to identify and rate dealers. OM system 110 may generate map 1120, which may include indicators 1140. Each indicator 1140 may identify a location of a dealer and an associated rating (ratings may include a relative ranking of the dealers). For example, each indicator 1140 may include a numerical value and/or a color code indicating the degree to which the dealer is favorable with respect to the selected factors. For instance, if competition is a selected factor, indicators 1140 may identify highly rated dealers as dealers in areas where competition is relatively low. In this way, if a user wants to focus on dealers where competition may be low, map 1120 may clearly guide the user in that process.

In some embodiments, map 1120 may further include a route 1150. Route 1150 may be automatically generated (e.g., by reports module 312), such as to indicate an ideal route that may be traveled to visit dealers with favorable ratings. In some instances, client device 120 may receive route 1150 as input from a user.

The mapping/routing sub-tool 450 may provide a use, such as a sales representative or sales manager, with a convenient automated tool that creates visualizations of dealers that correspond to selected criteria, thereby allowing the user to quickly and easily identify dealers that match certain factors. In addition, the incorporation of ratings allows OM system 110 to use certain factors, such as factors that a particular financial service provider chooses to emphasize (e.g., as indicating high-value, satisfying goals, representing opportunities, etc.), to further provide a visualization of the state of various dealers (or other entities) in a selected area. For example, a user may work toward a particular goal by selecting a factor related to the goal and visiting the dealers that are highly-rated, using the map (and possibly an automatically-generated driving route) as a guide.

Team Communication

In an exemplary embodiment, PAT 300 may further include a team communication function. For example, PAT 300 may provide one or more features that allow team members (e.g., individuals in a sales team or other defined group) to communicate with each other within PAT 300. In this way, an integrated communication function may allow for convenient and practical communication between team members, thereby promoting collaboration. Further, the communication function may allow for user to easily access and/or receive information related to other team members and use the information to efficiently complete tasks (e.g. tasks that require cooperation between more than one individual).

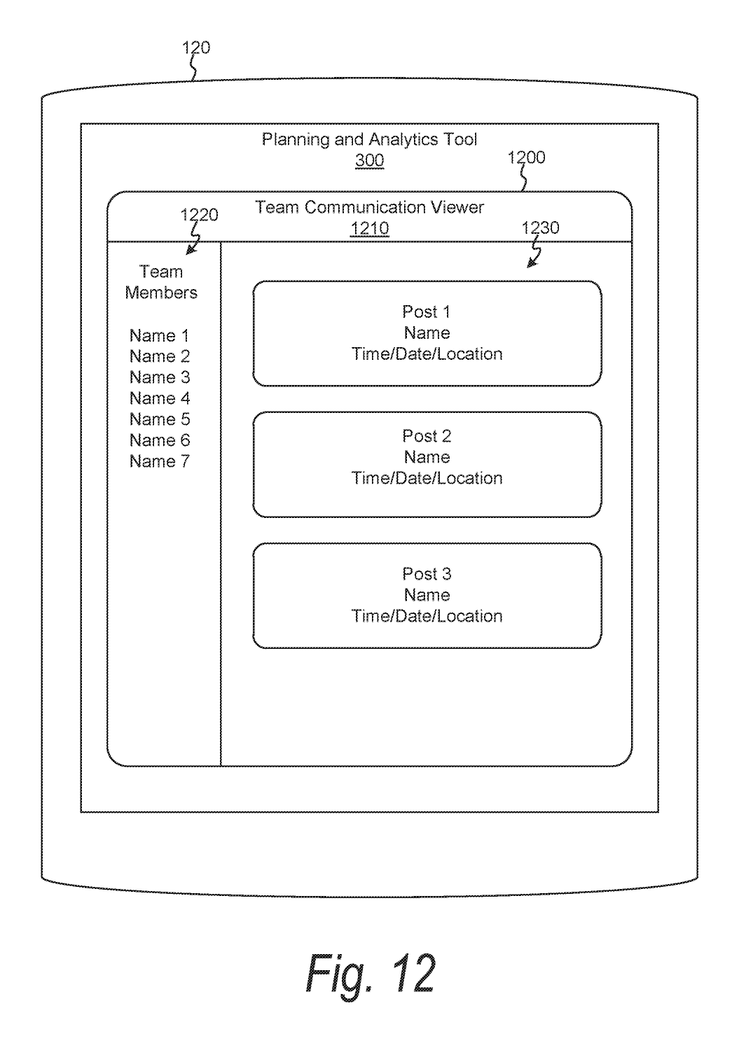

FIG. 12 is a block diagram of an exemplary user interface 1200, consistent with disclosed embodiments. In one embodiment, user interface 1200 includes a team communication viewer 1210, which may be an interactive interface by which users may provide and view information to communicate with others. For example, as shown in FIG. 12, user interface 1200 may include communication features such as a user contact list 1220 and a listing 1230 of user postings and/or messages. In an exemplary embodiment, client device 120 may generate user interface 1200 based on selection of team communication sub-tool 460 from dashboard 410.

A user may provide input to client device 120, which may be sent to communications module 316, which may operate to make the information available to other users. For example, the information may be provided as a post to team communication viewers 1210 of other client devices 120. It should be understood that the team communication function may include additional features, such as customized groups, user profiles, performance data, and the like, that may further enhance the team communication sub-tool 460.

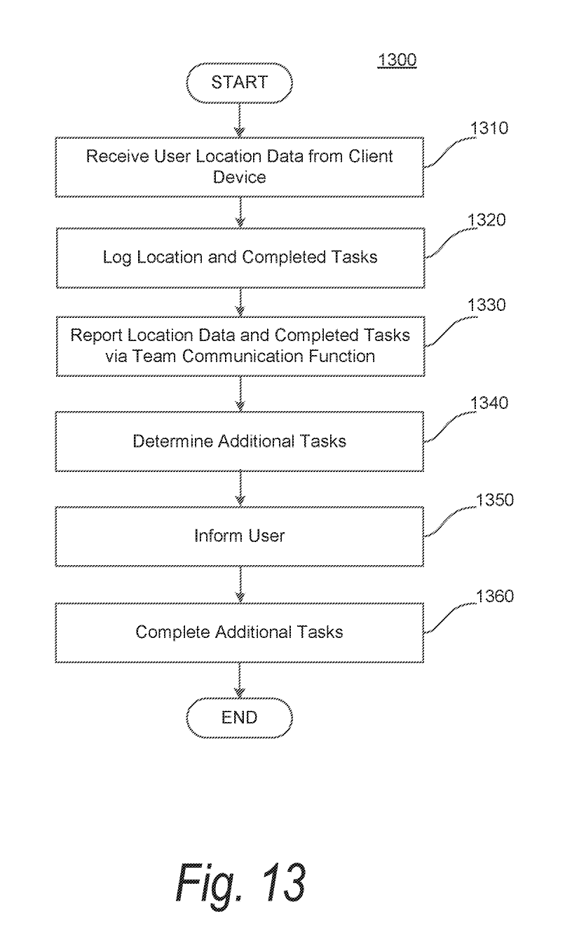

In some embodiments, OM system 110 may automatically identify particular tasks that may be completed based on information provided in a message or posting. FIG. 13 is a flowchart of an exemplary process 1300 for identifying and completing tasks related to information provided in a team communication via team communication sub-tool 460, consistent with disclosed embodiments.

In step 1310, OM system 110 may receive user information from client device 120. The user information may include information to be communicated to other users via the team communication function of PAT 300 (e.g., team communication sub-tool 460). In one example, the information to be communicated may include a location of the user. For example, the information may indicate a particular dealer at which the user is currently located. The user location may be input by the user to client device 120 (e.g., the user may “check-in” to a location), or client device 120 may automatically identify a location of a user. For example, client device 120 may track a location of a user and match the location of the user to an area of interest, such as a location corresponding to a dealer location. Client device 120 may provide the communication (e.g., location or other message) to OM system 110 (e.g., communications module 316).

In step 1320, OM system 110 may identify and store relevant aspects of the received information. For example, communications module 316 may identify a location of a user and any tasks that have been completed (or are planned) based on the received information. For instance, OM system 110 may receive information indicating that a user (e.g., sales representative) is at a particular dealer location and is meeting with a particular individual. OM system 110 (e.g., reports module 312) may store this information in order to track a user's daily activities.

In step 1330, OM system 110 may report information to other users via the team communication function of PAT 300. For example, communications module 316 may create a posting indicating that a user is located at a particular dealer. A user may input the posting (e.g., “currently located at Dealer X, will be meeting with person Y”) or communications module 316 (or another component of system 100) may automatically generate the posting.

In step 1340, OM system 110 may identify additional tasks that may be completed based on the information received from client device 120. For example, communications module 316 may identify pending tasks that require or request the presence of a user (e.g., sales representative) at a particular location. Some loan functions (e.g., completing a loan agreement) require that a sales representative in the field work with a back-end user (e.g., sales manager) to complete the loan function. In another example, OM system 110 may identify particular tasks that would be beneficial to a user for completing a goal and that may be completed while a user is at a particular location (e.g., meeting with a certain number of potential customers or existing customers to provide a service).

In step 1350, OM system 110 may provide the identified additional task(s) to a client device 120 to inform a user. For example, communications module 316 may determine that a sales manager should be informed of a location of a sales representative so that the two can work together to complete a pending loan agreement made at the dealer location. In another example, communications module 316 may inform an underwriter-user of a potential loan agreement that is taking place while a sales representative-user is at a dealer. The underwriter-user may use back-end tools to approve or deny the potential loan agreement, thereby providing quick and effective loan servicing. In step 1360, OM system 110 may complete the additional tasks. For example, communications module 316 may mark a pending loan agreement as completed.

The team communication feature of PAT 300 may provide users with a convenient and intuitive system by which they can communicate with others. This feature may be particularly useful in the context of a sales team, which often requires the input of multiple individuals to complete sales, meet goals, track progress, and the like. Further, the integration of the communication feature with the other features of PAT 300 allows for the automation of processes, such as process 1100 in which a relevant user may be quickly informed of information that may be useful in completing tasks.

The above-described embodiments and features are exemplary and the disclosed planning and analytics tool is not limited to them. Other embodiments may include additional or alternative features and/or may be configured to perform additional processes not specifically described herein.

The disclosed embodiments may provide a planning and analytics tool that is a comprehensive and combined suite of tools and functions that allows a user in the field of sales to efficiently identify and complete daily tasks that further the goals of the individual and the associated financial service provider. The integration of the multiple functions into the comprehensive tool may enhance the features, allowing for technical features that would not otherwise be available. For example, the data/reporting function may provide a robust data set for the other features to use in, for example, automatically setting goals, automatically planning daily tasks, rating dealers according to selected criteria, or identifying tasks that are associated with a user's current location. Further, the availability of the planning and analytics tool on a variety of computing devices, such as a mobile device, allows for flexible and convenient availability of the provided features. These and other advantages result in greater working efficiency for users, as they can spend less time deciding which tasks to complete and more time completing worthwhile tasks.

Computer programs created on the basis of the written description and methods of this specification are within the skill of a software developer. The various programs or program modules can be created using a variety of programming techniques. For example, program sections or program modules can be designed in or by means of Java, Objective C, C++, Java script, assembly language, or any such programming languages, including third-party libraries. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

What is claimed is:

1. An automated computing device for providing a planning and analytics tool, comprising:
a reports module configured to:
receive a data request for activity data associated with a plurality of entities,
locate and retrieve data corresponding to the request, and
provide the data corresponding to the request to a client device; and
a planning module configured to:
receive the activity data,
identify at least one task for a user to complete based on the activity data, and
provide the identified at least one task to the client device.

2. The automated computing device of claim 1, wherein providing the data corresponding to the request includes providing a data report.

3. The automated computing device of claim 2, wherein the data report includes at least one of a chart or graph that visually represents the data corresponding to the request.

4. The automated computing device of claim 1, wherein the activity data includes entity information, and the at least one task includes identification of an entity to visit.

5. The automated computing device of claim 4, wherein the planning module is further configured to generate a map of the identified at least one task and provide the map to the client device, wherein the map includes a plurality of indicators, wherein each indicator corresponds to a location for completing the at least one task.

6. The automated computing device of claim 1, wherein the planning module is further configured to receive goal-defining information and track progress towards completion of a goal.

7. The automated computing device of claim 6, wherein the planning module is further configured to automatically determine a goal benchmark.

8. The automated computing device of claim 7, wherein the planning module is further configured to provide an indication of goal progress to the client device.

9. The automated computing device of claim 1, further comprising a communications module configured to receive information from the client device and share the information with a second client device.

10. The automated computing device of claim 9, wherein the information includes a posting or message by a user.

11. The automated computing device of claim 9, wherein the information includes a location of a user that is automatically sent by the client device to the communications module based on the location corresponding to an entity.

12. An automated computing device for a sales representative, comprising:
a planning module configured to:
receive a selected factor associated with entities;
identify a plurality of entities that correspond to the selected factor;
determine a rating for each of the plurality of entities according to the selected factor; and
provide the identified entities and the ratings to a client device.

13. The automated computing device of claim 12, wherein the planning module is further configured to generate a map of the identified entities and provide the map to the client device.

14. The automated computing device of claim 13, wherein the map includes a plurality of indicators, wherein each indicator corresponds to a location of a dealer of the identified entities, and wherein the indicator includes the rating associated with the entities.

15. The automated computing device of claim 14, wherein the rating includes one or more of a numerical value, a ranking, color coding, or size coding.

16. The automated computing device of claim 13, wherein the planning module is further configured to determine a route between at least two of the identified entities.

17. The automated computing device of claim 16, wherein planning module is further configured to select the at least two of the identified entities based on the rating of the at least two identified entities.

18. A team communication system for a sales team, comprising:
a communications module configured to:
receive a location of a user based on a location of a first client device;
identify a task to be completed based on the location;
select a second client device based on the identified task; and
send an indication of the location to the second client device.

19. The team communication system of claim 18, wherein the first client device is associated with a sales representative and the second client device is associated with a sales manager.

20. The team communication system of claim 18, wherein the task is a loan servicing task.
